(19) United States
(12) Patent Application Publication
(10) Pub. No.: US 2006/0279812 A1
(43) Pub. Date: Dec. 14, 2006

(54) System and method for adjusting the reproduction of original images

(75) Inventor: Tetsuo Shiba, Kanagawa-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/147,439

(22) Filed: Jun. 8, 2005

(51) Int. Cl. G06K 15/02; G06F 15/00

(52) U.S. Cl. 358/532; 358/3.27; 358/1.2; 358/468

(57) ABSTRACT

A system and method for reproducing original images in an image forming apparatus includes determining a size of a binder area, a size of at least two original images, and a size of a paper upon which the at least two original images are reproduced, and calculating an image reduction amount for each of the at least two original images based on the determined sizes. The at least two original images are scanned into image data, which is adjusted in accordance with the calculated reduction amount. The at least two original images are reproduced on the paper based on the adjusted image data.

### FIELD OF THE INVENTION

The present invention relates generally to image processing and, more particularly, to a system and method for adjusting the reproduction of original images.

### BACKGROUND OF THE INVENTION

Image processing devices, and copiers in particular, typically allow for original documents on various predetermined sized papers to be copied onto the same or different sized papers. For example, a letter sized original document can be copied onto an A4 sized paper. It is also possible to copy multiple original document pages onto a single page, such as two A4 original document pages onto a single A3 sized paper, which is equal to double the size of a single A4 sized paper.

In conventional reproduction devices, the available print area is limited to the large A3 or LD sized papers. Any image outside of the dimensions of the A3 or LD sized papers is cut off. This limitation can be problematic in certain circumstances, such as printing pages on A3 or LD sized papers for a book to be bounded. When binding the book, it is necessary to include a binding area between the left and right hand pages. If the original pages are A4 sized paper, and they are copied onto A3 sized paper, then a portion of each original is lost depending upon the size of the binding area. For example, if the binding area is 2 cm, then when making the copy onto the A3 sized paper, the left page and the right page each lose 1 cm of image that extends into the binder area of the A3 sized paper. If the images for the original pages are moved outside the binder area, then the images would extend outside of the image forming area of the A3 sized paper, and each page would again lose 1 cm of image that extends outside of the image forming area.

Therefore, it would be desirable to have a reproduction device that was capable of reproducing images on any sized paper and which could adjust the positioning of multiple original images on a single page to account for printing requirements, such as for a bounded book.

### SUMMARY OF THE INVENTION

According to an aspect of the invention, a method for reproducing original images in an image forming apparatus includes determining a size of a binder area, a size of at least two original images, and a size of a paper upon which the at least two original images are reproduced, and calculating an image reduction amount for each of the at least two original images based on the determined sizes. The at least two original images are scanned into image data, which is adjusted in accordance with the calculated reduction amount. The at least two original images are reproduced on the paper based on the adjusted image data.

Further features, aspects and advantages of the present invention will become apparent from the detailed description of preferred embodiments that follows, when considered together with the accompanying figures of drawing.

### BRIEF DESCRIPTION OF THE DRAWINGS

FIG. 1 is a block diagram of an image forming apparatus consistent with the present invention.

FIG. 2 is a graphical representation of a 2:1 image reproduction consistent with the present invention.

FIG. 3 is a flow diagram of an image reproduction process consistent with the present invention.

FIG. 4 is a flow diagram of another image reproduction process consistent with the present invention.

### DETAILED DESCRIPTION OF THE PREFERRED EMBODIMENTS OF THE PRESENT INVENTION

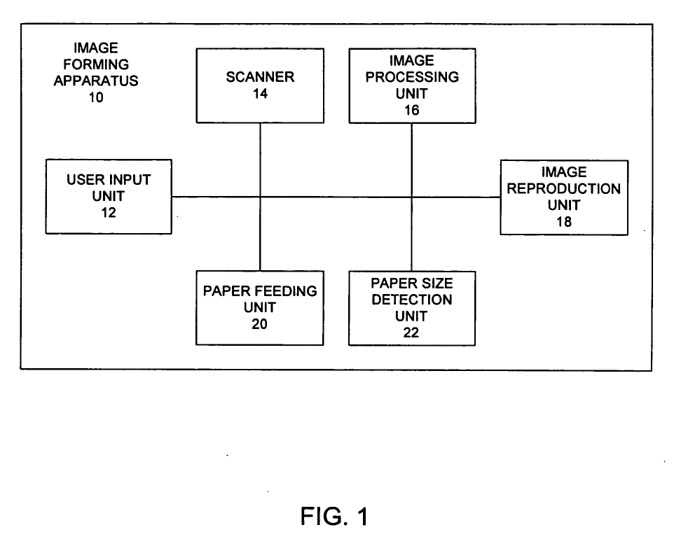

FIG. 1 is a block diagram of an image forming apparatus consistent with the present invention. As shown in FIG. 1, an image forming apparatus 10 includes a user input unit 12, a scanner 14, an image processing unit 16, an image reproduction unit 18, a paper feeding unit 20 and a paper size detection unit 22. The image forming apparatus 10 can be, for example, a copier or a multi-function peripheral or printer (MFP).

The user input unit 12 is an interface through which a user can input information to the image forming apparatus 10. The information input through the user input unit 12 includes settings of a copy job, such as number of copies, paper size, enlargement/reproduction amount, etc. The user input unit 12 can be implemented, for example, as a touch screen, an LCD display with corresponding buttons, or other configuration enabling a user to establish the settings of a copy job.

The scanner 14 scans original images from documents placed on a document table of the image forming apparatus 10. The documents can be placed on the document table, which is typically a glass plate, with an automatic document feeder (ADF) or by hand. The scanner 14 includes a light source, such as a lamp, that scans light across the document. The light reflected by the document is directed to a light detecting sensor, which converts the detected light into digital image data. The light detecting sensor can be implemented as a charge-coupled device (CCD).

The image data generated by the light detecting sensor of the scanner 14 is processed by the image processing unit 16. The image processing unit 16 can be configured to perform a variety of image processing functions. For example, the image processing unit 16 can perform image data conversion, gamma correction, compression, density adjustment, range compensation, halftone processing, dithering, error diffusion, smoothing, filtering, enlargement/reduction or other image processing functions.

The processed image data from the image processing unit 16 is used by the image reproduction unit 18 to reproduce the scanned original image from the document onto a copy paper. The copy paper can be any type of media to which toner can be fixed, such as a standard paper sheet, a paper having a surface coating, or overhead transparency sheets. The image reproduction unit 18 can include an ink source, such as a developer or ink, an image generating unit for generating a latent image from the processed image data, an image transfer unit for transferring the latent image to the copy paper and a fusing unit for fusing the image to the copy paper.

The copy paper is provided to the image reproduction unit 18 by a paper feeding unit 20. The paper feeding unit 20 can include one or more cassettes holding one or more sizes of copy paper and transfer mechanisms for transferring the copy paper from the cassettes to the image reproduction unit 18. The paper feeding unit 20 can also include a manual feed portion that enables a user to feed variably sized paper to the image reproduction unit 18.

The paper size detection unit 22 is configured to detect the feed length of a sheet of copy paper provided to the image reproduction unit 18 by the paper feeding unit 20. The paper size detection unit 22 is preferably located adjacent to the paper feeding unit 20. The paper size detection unit 22 can include a sensor which detects the leading and trailing edges of the sheet of copy paper and calculate its feed length based on the time between detecting the leading and trailing edges. It is also possible for the paper size detection unit 22 to detect the size of original image documents fed to the document table by an ADF.

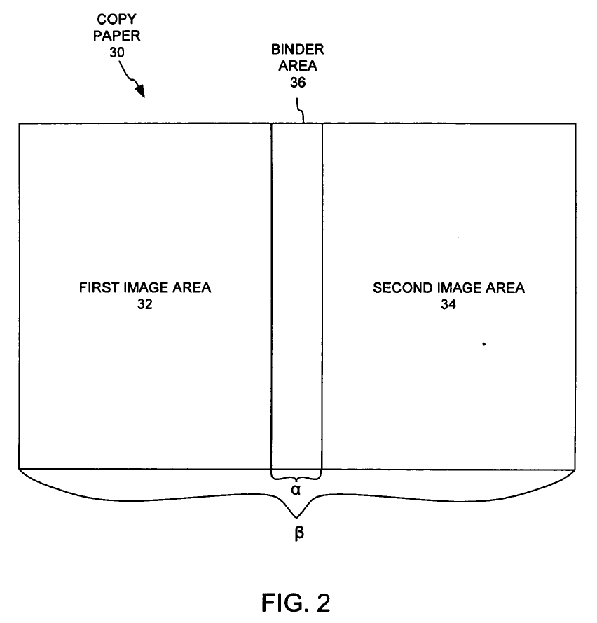

FIG. 2 is a graphical representation of a 2:1 image reproduction consistent with the present invention. As shown in FIG. 2, a copy paper 30 includes a first image area 32 and a second image area 34. The first and second image areas 32, 34 correspond to portions of the copy paper 30 where an image can be reproduced or formed. The first and second image areas 32, 34 are separated by a binder area 36. The binder area 36 is a section in which an image should not be formed. For example, if the copy paper 30 is included in a book, the binder area 36 corresponds to the bounded section of the book where no image can be seen.

As also shown in FIG. 2, a represents the length of the binder area 36, and β represents the length of the copy paper 30. These lengths are measured in the feed direction of the copy paper 30, i.e., the direction in which the copy paper 30 is fed into the image forming apparatus 10. The sizes of the first and second image areas 32, 34 can be determined from a and β. In particular, the size of each is equal to one half of the difference between β and α. For example, if the copy paper is A3 sized (which is twice the length of an A4 sized paper), and a is 2 cm, then the size of each of the first and second image areas 32, 34 is 1 cm shorter than an A4 sized paper.

As described above, when two original images are copied onto a single copy paper having a binder area, there is the potential that a portion of the images will be lost if included in the binder area or extend outside of the image forming area of the copy paper or the image forming apparatus. In accordance with an aspect of the present invention, it is possible to copy the two original images onto the single copy paper having a binder area without losing portions of the original images.

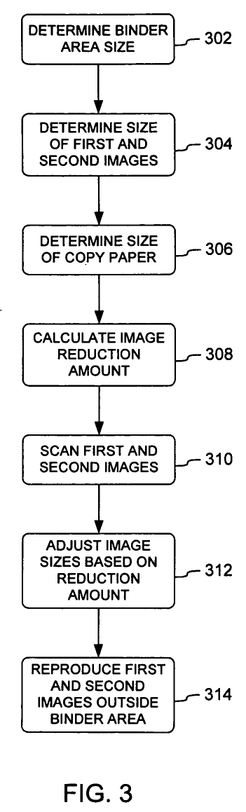

FIG. 3 is a flow diagram of an image reproduction process consistent with the present invention. As shown in FIG. 3, a binder area size is determined (step 302). The binder area size, which corresponds to the binder area length β, can be determined in a number of ways. For example, a user can enter the binder area size α through the user input unit 12. It is also possible, as will be described below, to determine the binder area size α from the size of the original images and the size of the copy paper 30.

In addition to determining the binder area size α, a size is determined for the first and second original images that are being reproduced on the copy paper 30 (step 304). Like the binder area size α, the original image sizes can be determined by information input to the user input unit 12 by a user. Alternatively, the original image sizes can be determined automatically by the paper size detection unit 22. For example, if the original images are fed to the image forming apparatus 10 with an automatic document feeder (ADF), then the paper size detection unit 22 can determine the size of each of the original images after each one is fed into the image forming apparatus 10 by the ADF. In particular, the paper size detection unit 22 can detect the leading and trailing edges of each original image and determine the size from the time difference between detecting each edge. The paper size detection unit 22 can also determine the size of each original page from the image data generated by the scanner 14.

The size of the copy paper 30 is also determined (step 306). Like the other size information, the size of the copy paper 30, which includes the length β of the copy paper 30, can be determined from information entered by the user through the user input unit 12. The size of the copy paper can also be determined by the paper size detection unit 22, which detects the leading and trailing edges of each original image and determines the size from the time difference between detecting each edge.

Based on the size of the copy paper 30 and the size of the original images, it is possible to determine the size of the binder area 36 if it is not predetermined or designated by the user. If the size of the copy paper 30 is larger than the combined size of the first and second original images, then the binder area size α can be set as the difference between the size of the copy paper 30 and the combined size of the first and second original images. For example, if each of the original images is on A4 sized paper, and the copy paper 30 is larger than A3 sized paper (which is twice the size of A4), then the binder area size α corresponds to the extent that the copy paper 30 is larger than the A3 sized paper.

Based on the determined sizes for the binder area 36, first and second images, and the copy paper 30, an image reduction amount is calculated (step 308). The image reduction amount corresponds to the amount that the first and second original images need to be reduced to fit within the first and second image areas 32, 34, respectively. As described above, the sizes of the first and second image areas 32, 34 can be determined from the size information of the copy paper 30 and the binder area size α. The actual reduction amount can be determined in accordance with a ratio of the size of the first and second image areas 32, 34 to the size of the first and second original images. Other techniques may be used, as are known to those skilled in the art, for determining the image reduction amount based on the size of the first and second image areas 32, 34 and the size of the first and second original images. The image reduction amount can be calculated by a processing unit in the image forming apparatus 10 such as in the image processing unit 16.

If not already done to determine their sizes, the first and second original images are scanned by the scanner 14 (step 310). The scanner 14 can scan both original images at the same time on the document table or one at a time, such as when the original images are fed to the image forming apparatus 10 by an ADF. The scanner 14 detects the light reflected by the first and second original images and converts the detected light into first and second image data, which correspond to the first and second original images, respectively.

The first and second image data is then adjusted by the image processing unit 16 in accordance with the image reduction amount (step 312). The image processing unit 16 transforms the first and second image data so that the first and second original images can be reproduced in the first and second image areas 32, 34 without cutting off any portion of the first and second original images. Implementing the algorithm for reducing image data is understood by one skilled in the art. An example of such an algorithm for reducing image data is disclosed in U.S. application Ser. No. 09/641,337 to Hamamura et al., filed on Aug. 18, 2000. It should be understood, however, that other reduction algorithms may be used. In addition to the image reduction, the image processing unit 16 can perform other image processing functions, such as image data translation or halftone processing.

The image reproduction unit 18 reproduces the first and second original images on the copy paper 30 outside the binder area 36 based on the first and second image data (adjusted by any reduction amount) output from the image processing unit 16 (step 314). The image reproduction unit 18 preferably includes controls to ensure that the first and second original images are reproduced in the first and second image areas 32, 34 and not in the binder area 36. These controls can include, for example, controlling the transfer timing of the latent images of the first and second original images to a photoelectric drum. The controls for the image reproduction unit 18 enable the image forming apparatus 10 to form images on copy paper 30 of variable sizes, including copy paper 30 that is larger than A3 or LD sized paper.

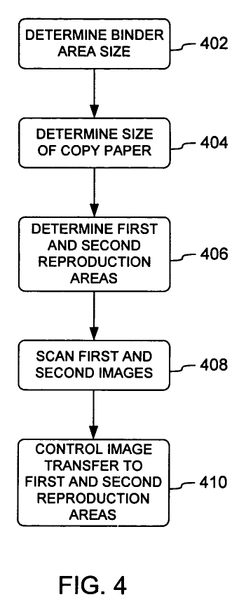

FIG. 4 is a flow diagram of another image reproduction process consistent with the present invention. This image reproduction process is directed to the formation of first and second original images on copy paper 30 that is larger than the combined size of the first and second original images. It is also possible for this process to be operated in conjunction with the image reproduction process of FIG. 3.

Like the process of FIG. 3, the image reproduction process of FIG. 4 determines the size of the binder area 36 (step 402) and the size of the copy paper 30 (step 404). The size of the binder area 36 and the copy paper 30 can be determined in the same manner as described above with respect to steps 302 and 306 of FIG. 3.

The first and second image areas 32, 34 are then determined in accordance with the determined size of the binder area 36 and the copy paper 30 (step 406). As described above, the first and second image areas 32, 34 can be determined by taking one half of the difference between the size of the copy paper 30 (more specifically the length β) and the size of the binder area 36 (more specifically the length β).

In addition, the scanner 14 scans the first and second original images and generates first and second image data corresponding to the first and second original images, respectively (step 408). The manner in which the scanner 14 scans the first and second original images and forms the first and second image data is the same as described above in connection with step 310 of FIG. 3. The size of the first and second original images can be determined from the first and second image data or by the paper size detection unit 22. It is then determined if the sizes of the first and second original images are either less than or equal to the sizes of the first and second image areas 32 and 34, respectively. If they are not, then an image reduction amount can be calculated and applied to the first and second image data in accordance with steps 308 and 312 of FIG. 3.

If the determined sizes of the first and second original images are in fact less than or equal to the sizes of the first and second image areas 32 and 34, respectively, then it is possible to form the first and second original images in the respective image areas 32, 34 without cutting off any portion of the original images. In addition, if the sizes of the first and second original images are smaller than the sizes of the first and second image areas 32 and 34, it is possible to adjust the position of the original images in the image areas 32, 34. The position adjustment can be controlled or selected by the user or can be set to a default position by the image forming apparatus 10. For example, the image forming apparatus 10 can include a display showing the original images in the respective image areas 32, 34 and include controls that enable the user to move the original images to a desired position. Alternatively, a default setting can be for the original images to be placed, for example, on the edge of the copy paper 30 away from the binder area 36, in the center of the image areas 32, 34, or on the edge of the binder area 36 away from the edge of the copy paper 30.

The transfer of the original images to the image areas 32, 34 is then controlled to form the original images in the image areas 32, 34 and not in the binder area 36 (step 410). If smaller than the image areas 32, 34, then the original images can be formed in the position selected by the user or in the default position set by the image forming apparatus 10. The original images are formed in the image areas 32, 34 by the image reproduction unit 18. As described above, the image reproduction unit 18 can include controls such as controlling the speed in which the copy paper 30 is fed through the image forming apparatus 10 and the transfer timing of the latent images of the first and second original images to the photoelectric drum, which ensure that the original images are formed in the appropriate locations.

The foregoing description of preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments (which can be practiced separately or in combination) were chosen and described in order to explain the principles of the invention and as practical application to enable one skilled in the art to utilize the invention in various embodiments and with various modifications suited to the particular use contemplated. It is intended that the scope of the invention be defined by the claims appended hereto and their equivalents.

What is claimed is:

1. A method for reproducing original images in an image forming apparatus, comprising:
determining a size of a binder area, a size of at least two original images, and a size of a paper upon which the at least two original images are reproduced;
calculating an image reduction amount for each of the at least two original images based on the determined sizes;
scanning the at least two original images into image data;
adjusting the image data in accordance with the calculated reduction amount; and
reproducing the at least two original images on the paper based on the adjusted image data.

2. A method according to claim 1, wherein the reproducing includes forming the at least two original images outside of the binder area.

3. A method according to claim 1, wherein the calculating of the image reduction amount includes:
dividing the difference between the paper size and the binder area size by the sum of the sizes of the at least two original images,
wherein the image reduction amount is based on the dividend.

4. A method according to claim 1, wherein the determining includes:
receiving information identifying the paper size and the binder area size; and
automatically detecting the size of the at least two original images.

5. A method according to claim 1, wherein the determining includes:
receiving information identifying the binder area size; and
automatically detecting paper size and the size of the at least two original images.

6. A computer readable medium operable in an image forming apparatus configured to perform the method of claim 1.

7. A method for reproducing first and second original images on a paper in an image forming apparatus, a size of the paper being larger than a combined size of the first and second original images, comprising:
determining the size of the paper and a size of a binder area;
determining a first location for reproducing the first original image on the paper exclusive of the binder area;
determining a second location different from the first location for reproducing the second original image on the paper exclusive of the binder area;
scanning the first and second original images into first and second image data, respectively; and
reproducing the first original image in the first location on the paper based on the first image data and the second original image in the second location on the paper based on the second image data.

8. A method according to claim 7, wherein the first and second original images are each on A4 paper.

9. A method according to claim 8, wherein the paper size is larger than A3.

10. A method according to claim 7, wherein the determining includes automatically detecting the paper size.

11. A method according to claim 10, wherein the paper size is automatically detected in accordance with a time at which a trailing edge of the paper is detected by a sensor.

12. A method according to claim 11, wherein the reproducing includes controlling a transfer timing of the first original image to the first location on the paper and the second original image to the second location on the paper in accordance with the automatically detected paper size.

13. A method according to claim 7, wherein the determining includes:
detecting the combined size of the first and second original images; and
calculating the size of the binder area based on a difference of the paper size and the combined size of the first and second original images.

14. A computer readable medium operable in an image forming apparatus configured to perform the method of claim 7.

15. An image forming apparatus for reproducing original images, comprising:
a scanner that scans first and second original images and generates first and second image data from the scanned first and second original images, respectively;
an image processing unit that calculates an image reduction amount for the first and second image data based on a size of a binder area, a size of the first and second original images, and a size of a paper upon which the first and second original images are reproduced, and adjusts the first and second image data in accordance with the calculated reduction amount; and
an image reproduction unit that reproduces the first and second original images on the paper based on the adjusted first and second image data.

16. An image forming apparatus according to claim 15, wherein the image reproduction unit forms the at least two original images outside of the binder area.

17. An image forming apparatus according to claim 15, wherein the image processing unit is configured to divide the difference between the paper size and the binder area size by the sum of the sizes of the at least two original images and determine the image reduction amount based on the dividend.

18. An image forming apparatus according to claim 15, further comprising:
a user input unit that provides information identifying the paper size and the binder area size; and
a paper size detection unit that detects the size of the first and second original images.

19. An image forming apparatus according to claim 15, further comprising:
a user input unit that provides information identifying the binder area size; and
a paper size detection unit that detects the paper size.

20. An image forming apparatus for reproducing first and second original images on a paper, a size of the paper being larger than a combined size of the first and second original images, comprising:
a scanner that scans the first and second original images and generates first and second image data from the first and second original images, respectively;
an image processing unit that determines a first location for reproducing the first original image on the paper exclusive of the binder area based on the size of the paper and a size of a binder area, and determines a second location different from the first location for reproducing the second original image on the paper exclusive of the binder area based on the size of the paper and the size of the binder area; and
an image reproduction unit that reproduces the first original image in the first location on the paper based on the first image data and the second original image in the second location on the paper based on the second image data.

21. An image forming apparatus according to claim 20, wherein the first and second original images are each on A4 paper.

22. An image forming apparatus according to claim 21, wherein the paper size is larger than A3.

23. An image forming apparatus according to claim 20, further comprising:
a paper size detection unit that detects the paper size.

24. An image forming apparatus according to claim 23, wherein the paper size detection unit includes a sensor that identifies a time at which a trailing edge of the paper is detected,
wherein the paper size detection unit determines the paper size based on the identified time.

25. An image forming apparatus according to claim 24, wherein image reproduction unit includes a control unit that controls a transfer timing of the first original image to the first location on the paper and the second original image to the second location on the paper in accordance with the detected paper size.

26. An image forming apparatus according to claim 20, wherein the image processing unit is configured to detect the combined size of the first and second original images, and calculate the size of the binder area based on a difference of the paper size and the combined size of the first and second original images.
